(19) United States
(12) Patent Application Publication
(10) Pub. No.: US 2019/0308455 A1
(43) Pub. Date: Oct. 10, 2019

(54) TIRE COMPRISING A TREAD CONTAINING CIRCUMFERENTIAL REINFORCING ELEMENTS IN THE SUBLAYER

(71) Applicant: COMPAGNIE GENERALE DES ETABLISSEMENTS MICHELIN, CLERMONT-FERRAND (FR)

(72) Inventor: FRÉDÉRIC PERRIN, CLERMONT-FERRAND (FR)

(21) Appl. No.: 16/465,701

(22) PCT Filed: Nov. 27, 2017
(86) PCT No.: PCT/FR2017/053257

§ 371 Date: May 31, 2019

(30) Foreign Application Priority Data
Dec. 2, 2016 (FR) 1661861

(51) Int. Cl. B60C 11/00; B60C 11/18

(52) U.S. Cl. CPC B60C 11/0075; B60C 2011/0033; B60C 2011/0025; B60C 11/18

(57) ABSTRACT

A tire (1) comprises two beads (4), two sidewalls (3) connected to the beads and a crown (2) connected to the ends of the two sidewalls, the crown comprising a crown reinforcement (6) and a tread (5) radially outside the crown reinforcement (6), said tread (7) comprising a plurality of tread pattern blocks (71), at least two radially superposed layers: a sublayer (7S) covering the crown reinforcement (6), and a main layer (7P) radially above the crown reinforcement (6), the sublayer comprising a plurality of circumferential reinforcing elements (73) being formed of a rubber compound having greater stiffness than the stiffness of the rubber compound of the rest of the sublayer, the circumferential reinforcing elements (73) extending radially from the radially exterior surface of said crown reinforcement (6) in the direction of the interface between the sublayer (7S) and the main layer (7P), said circumferential reinforcing elements having an axial width which decreases gradually with increasing radial proximity to the outside.

### FIELD OF THE INVENTION

The present invention relates to tyres, and more particularly to a tyre the grip performance of which is improved.

In general, a tyre is an object with a geometry exhibiting symmetry of revolution about an axis of rotation. A tyre comprises two beads intended to be mounted on a rim; it also comprises two sidewalls connected to the beads, a crown comprising a tread intended to come into contact with the ground, the crown having a first side connected to the radially outer end of one of the two sidewalls and having a second side connected to the radially outer end of the other of the two sidewalls.

The makeup of the tyre is usually described by a representation of its constituent components in a meridian plane, that is to say a plane containing the axis of rotation of the tyre. The radial, axial and circumferential directions denote the directions perpendicular to the axis of rotation of the tyre, parallel to the axis of rotation of the tyre and perpendicular to any meridian plane, respectively. In the following text, the expressions “radially”, “axially” and “circumferentially” mean “in a radial direction”, “in the axial direction” and “in a circumferential direction” of the tyre, respectively. The expressions “radially on the inside” and “radially on the outside” mean “closer to” and “further away from the axis of rotation of the tyre, in a radial direction”, respectively. The equatorial plane is a plane perpendicular to the axis of revolution of the tyre, positioned axially in such a way as to intersect the surface of the tread substantially mid-way between the beads. The expressions “axially on the inside” and “axially on the outside” mean “closer to” and “further away from the equatorial plane of the tyre, in the axial direction”, respectively.

### PRIOR ART

As is known, tyres for road applications, and very particularly tyres for passenger vehicles, make an essential contribution to the performance of the vehicles in terms of rolling resistance (and thus energy efficiency of the vehicles), of grip, of dynamic response for guiding the vehicles (notably when cornering) and of wear (and thus overall cost of using the vehicles). Of the tyre design parameters, those skilled in the art are aware of the importance of the choice of the material constituting the tread and of the material constituting a layer frequently referred to as “sublayer”, which is a layer sandwiched between the crown reinforcement of a tyre and the wear portion of the tread. One example of a sublayer, that is to say of a layer of rubber interposed between the crown reinforcement and the material of the tread, is described in the document FR 2 954 333. In general, sublayer materials under the tread are used to improve the rolling resistance of the tyre with a material of low hysteresis, or to stiffen the tread in shear, but with modest stiffnesses so as not to excessively counter the flattening of the tread of the tyre in its contact patch in which it is in contact with the ground.

However, the lower the stiffness of the sublayer, the poorer the drift thrust response of the tyre is when subjected to stress by the vehicle turning. Specifically, schematically, the stack of layers of rubber radially on the outside of the crown reinforcement can be considered to be a succession of springs in series. It is for this reason that the introduction of materials with too low a modulus is avoided so as not to impair the cornering stiffness. However, this may conflict with the objective of minimizing the rolling resistance. Even in the variants with the greatest stiffnesses, the dynamic shear modulus G* of a sub-layer material is generally much less than 8 MPa, even when the best performance in terms of handling is desired. In the present document, it is noted that the dynamic shear modulus G* in question is the dynamic shear modulus G* measured at 23° C. and under an alternating shear stress of 0.7 MPa at a frequency of 10 Hz.

Document WO 2015/170615 also discloses a tyre comprising three layers formed of three radially superposed materials. The modulus of the material of the tread and the tg δ (tangent delta) value thereof are lower than the values of the same parameters of the sub-layer material in contact with the tread material, that is to say that of the two radially outermost layers. The modulus of the material of the radially inner layer of the sub-layer materials and the tg δ value thereof are lower than the values of the same parameters of the sub-layer material in contact with the tread material. However, a tyre made according to this teaching does not achieve any progress in terms of the balance of performance properties.

In order to improve the grip of a tyre, and more particularly for grip on dry and wet ground, it is well known to reduce the stiffness or the hardness of the rubber compound forming the tread. This reduction in tread stiffness allows the tread to better match the rough surface of the ground it is running on and thus the actual area of contact with the ground it is running on is increased and the grip performance improved with respect to a tread of which the rubber compound is stiffer.

As is known, the tread of a tyre is provided with a tread pattern comprising, notably, tread pattern blocks delimited by various main, longitudinal or circumferential, axial or else oblique grooves, the elementary tread pattern blocks also being able to have various finer slits or sipes. The grooves form channels for draining off water when running on wet ground. The walls of these grooves also define the edges of the tread pattern blocks; depending on the orientation of the forces to which a running tyre is subjected, reference is made to a leading edge of a tread pattern block when the force is oriented towards the centre of the block, the trailing edge of a tread pattern block being the opposite edge. With this in mind, while the use of a less stiff rubber tread compound promotes grip, it also promotes shearing of the tread pattern blocks when the tyre needs to oppose an axially oriented force, and this causes the tread pattern blocks to rock; that generates greatly raised pressures on the leading edges of the tread pattern blocks; these greatly raised pressures in turn generate very significant heating.

These raised pressures and this heating can contribute towards very rapid damage to the tread of the tyre and towards non-optimal exploitation of the grip potential of the tread compound.

Document EP0869016 A2 discloses a tyre with a tread comprising two superimposed rubber compounds, in which the interior and exterior compounds have different characteristics, in order to maintain good grip of the tyre after the tread has become partially worn and this interior compound has been revealed at the surface. However, a significant increase in the rolling resistance of such a tyre is observed in comparison with a tyre which, in its tread, uses only the low-stiffness compound, with all other factors being equal. Documents JP2014/11392 A and US2015/107735 also present tyres with treads comprising two different rubber compounds.

In order to improve the grip performance of the tyres by stabilizing the tread pattern blocks, document EP 2 708 382 A1 proposes a tyre, the tread of which comprises a circumferential reinforcement made of a rubber compound of a stiffness higher than the stiffness of the compound of the rest of the tread. This tyre is such that the circumferential reinforcement has a reinforcing element that is positioned under each circumferential groove and extends radially from the radially interior surface of the tread until it forms the entire bottom of the groove. The reinforcement of the circumferential grooves that is thus produced makes it possible to increase the drift thrust of the tyre, but the presence of a stiff compound in the groove bottom makes it difficult to mould the wear indicators. A significant increase in the rolling resistance associated in particular with the limiting of the transverse and longitudinal flattening of the tread in the axial direction and in the longitudinal direction is also observed.

In order to provide an improvement to overall performance in the event of using rubber tread compounds of low stiffness, document WO2016/174100 proposes using a rubber tread compound of low hardness and reinforcing the tread by including therein one or more circumferential reinforcements having a triangular shape, viewed in meridional section, said triangle having its vertex oriented radially outwards.

In another context, document EP1508457 shows a tyre comprising a stack of different materials as tread, and comprising a plurality of convex elements; it should also be noted that document JP2011/183994 shows elements of a particular shape arranged under the groove bottoms.

None of these teachings makes it possible to use high-grip rubber compounds for the tread without leading either to rapid wearing when the tyre is heavily loaded or to too great a degradation in the rolling resistance of the tyre.

### BRIEF DESCRIPTION OF THE INVENTION

A subject of the invention is a tyre comprising a crown reinforcement and a tread radially outside the crown reinforcement, said tread comprising:
at least two grooves extending at least partially circumferentially, each groove being delimited radially towards the inside by a groove bottom, the tread having a contact face intended to come into contact with the roadway when the tyre is being driven on and a wear limit level situated radially on the outside of said groove bottom,
a plurality of tread pattern blocks, two axially adjacent blocks being axially separated by one of said grooves,
at least two radially superposed layers: a sublayer covering the crown reinforcement, and a main layer radially above the crown reinforcement,
characterized in that the sublayer comprises at least two circumferential reinforcing elements arranged axially between two axially consecutive grooves,
in that said circumferential reinforcing elements are formed of a rubber compound having greater stiffness than the stiffness of the rubber compound of the rest of the sublayer,
in that the circumferential reinforcing elements extend radially from the radially exterior surface of said crown reinforcement in the direction of the interface between the sublayer and the main layer, said circumferential reinforcing elements having an axial width which decreases gradually with increasing radial proximity to the outside as far as the radial end thereof.

Due to their high shear stiffness, the circumferential reinforcing elements oppose the shearing of the sublayer, which makes it possible to adopt for said sublayer, aside from reinforcing elements of course, materials with very low loss and low stiffness without the usual degradation in drift thrust occurring. Moreover, it is preferably possible to distribute the reinforcing elements regularly over the entire axial width of the tyre; since the addition of the reinforcing elements is axially symmetrical, there is no unwanted axially-oriented axial thrust as can be observed with non-axially-symmetrical designs. In addition, due to their small radial height, the circumferential reinforcing elements do not significantly oppose the flattening of the crown of the tyre when the tread is in the contact patch in which it is in contact with the ground; this results in excellent rolling resistance performance.

Since the circumferential reinforcing elements are not (or at least not substantially) arranged in the wear portion of the tread, this makes it possible not to disrupt the contact of the tyre on the roadway; grip is thus conserved until total wear occurs. This reinforcement in terms of axial shear enables an improvement in the cornering stiffness of the tyre and therefore the road holding of the vehicle.

The circumferential reinforcing element also has the important feature of bearing directly on the crown reinforcement of the tyre. This makes it possible to have a good bearing point for stiffening the crown and the tread.

It should also be noted that the invention ensures excellent stiffening by using a relatively small volume of high-stiffness rubber, representing of the order of 5% to 15% of the total volume of rubber in the tread, this leading to a significant advantage in terms of grip, in terms of wear, in terms of the rolling resistance of the tyre, as compared with the tyres disclosed in the aforementioned document EP 2 708 382 A1.

Advantageously, the rubber compound constituting each circumferential reinforcing element has a dynamic shear modulus G*, measured at 60° C. at 10 Hz and under an alternating shear stress of 0.7 MPa, of greater than 3 MPa and preferentially greater than 5 MPa and even more preferentially greater than 10 MPa; in addition, preferably, the dynamic shear modulus G* of the rubber compound constituting the circumferential reinforcing elements is at least two times greater than the dynamic shear modulus G* of the rubber compound of the rest of the sublayer (aside from the circumferential reinforcing elements); for example, the dynamic shear modulus G* thereof, measured at 60° C. at 10 Hz and under an alternating shear stress of 0.7 MPa, is preferably less than 3 MPa and preferentially less than 1.5 MPa.

Highly advantageously, the rubber compound of the main layer of the tread has a dynamic shear modulus G*, measured at 60° C. at 10 Hz and under an alternating shear stress of 0.7 MPa, of less than or equal to 1.6 MPa and preferably less than 1.3 MPa. The presence of the circumferential reinforcement makes it possible to make full use of the grip capabilities of such a very low stiffness tread compound. This is particularly useful in the case of a tyre for a passenger vehicle.

The invention relates more particularly to tyres intended to equip motor vehicles having four or more wheels (passenger vehicle, notably of sports type, SUV (“Sports Utility Vehicles”)) type, or also to equip two-wheeled vehicles (especially motorcycles) or else aircraft, industrial vehicles chosen from vans, “heavy-duty vehicles” (that is to say, underground trains, buses, heavy road transport vehicles—lorries, tractors, trailers—or off-road vehicles, such as heavy agricultural or construction plant vehicles), and other transportation or handling vehicles. The invention may equally well be applied to inflated assemblies referred to as “pneumatic tyres” or to non-pneumatic tyre assemblies.

### DESCRIPTION OF THE FIGURES

The objects of the invention will now be described with the aid of the appended drawing, in which:

FIG. 1 depicts, highly schematically (without being true to a specific scale), a meridional section through a tyre in accordance with one embodiment of the invention;

FIGS. 2 to 4 depict, in meridional section, tyres according to different embodiments of the invention;

FIG. 5 depicts different variant embodiments of an element according to the invention.

### DETAILED DESCRIPTION OF THE INVENTION

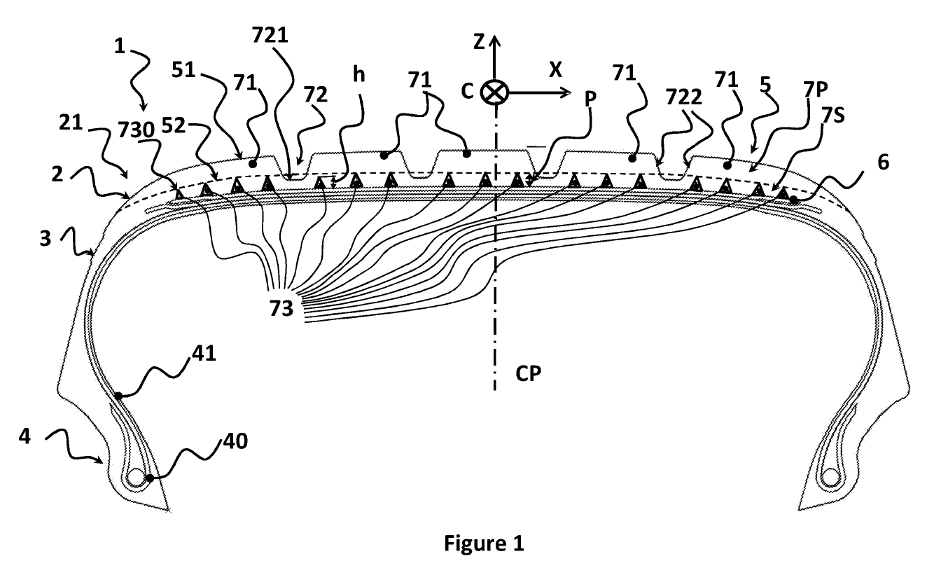

FIG. 1 shows a tyre 1 comprising a crown 2, two sidewalls 3 each connected to a bead 4. The crown 2 is connected on each side to the radially exterior end of each of the two sidewalls. The crown 2 comprises a tread 5. FIG. 1 indicates an equatorial plane CP, which plane is perpendicular to the axis of rotation of the tyre, situated mid-way between the two beads 4 (mounted on rim) and passing through the middle of the axial width of the crown 2; FIG. 1 also indicates, by arrows placed just above the tread 5, on the equatorial plane CP, the axial X, circumferential C and radial Z directions.

Each bead has a bead wire 40. A carcass ply 41 is wrapped around each bead wire 40. The carcass ply 41 is radial and is, in a manner known per se, made up of cords; in this implementation, textile cords; these cords are arranged substantially parallel to one another and extending from one bead to the other in such a way that they form an angle of between 80° and 90° with the equatorial plane CP.

From a geometrical perspective, the tread 5 comprises a plurality of tread pattern blocks 71. Two axially adjacent tread pattern blocks 71 are separated by a groove 72 extending at least partially circumferentially; each groove 72 is delimited radially towards the inside by a groove bottom 721 and lateral groove walls 722. The tread has a contact face 51 intended to come into contact with the roadway when the tyre is being driven on and a wear limit level 52 situated radially on the outside of said groove bottom 721.

From the perspective of the constituent materials, the tread 5 comprises two radially superposed layers: one sublayer 7S directly covering the crown reinforcement 6, and a main layer 7P radially directly above the sublayer 7S (considering the thin layer of calendering materials of the cords or threads of the crown reinforcement 6 to form part of said crown reinforcement layer). “Sublayer” usually refers to the layer of rubber compound which is not part of the wear layer of the tread, said wear layer being referred to in the present document as “main layer”. The limit between the sublayer 7S and the main layer 7P is shown as a dashed line. The sublayer 7S extends radially substantially at the level of said wear limit 52.

It can be seen in FIG. 1 that the tyre comprises three circumferential reinforcing elements 73 distributed axially between two grooves 72. Said circumferential reinforcing elements 73 comprise a radial end 730. Said circumferential reinforcing elements 73 are arranged axially facing a tread pattern block 71. The tyre also comprises four circumferential reinforcing elements 73 distributed axially between each of the shoulders 21 of the tyre and each of the axially outermost grooves 72; each group of four circumferential reinforcing elements 73 is also arranged axially facing a tread pattern block 71, that which is the radially outermost of the tread. It should be noted that, in the variant embodiment illustrated in FIG. 1, the sublayer 7S is formed of the same rubber compound as the main layer 7P.

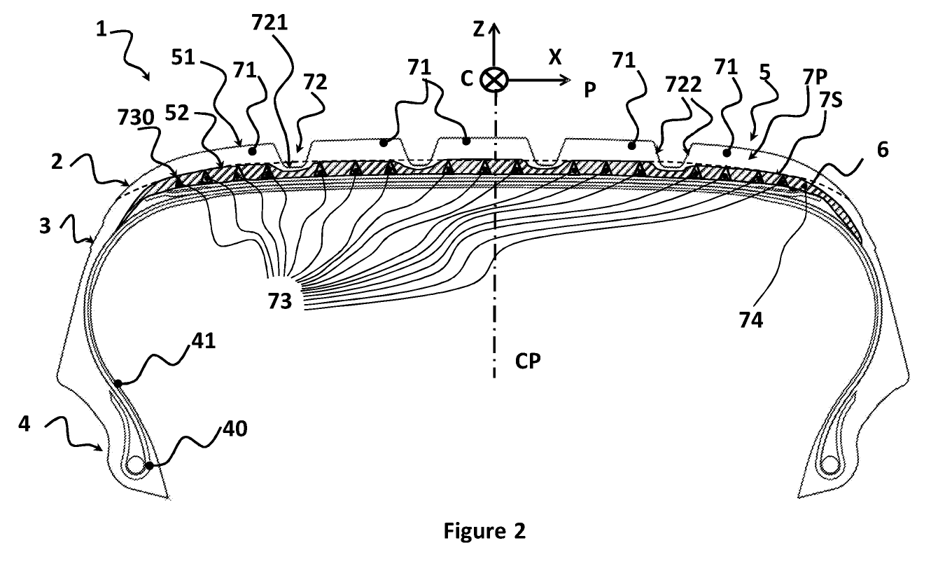

The variant embodiment illustrated by means of FIG. 2 differs from the preceding embodiment in that the sublayer 7S is formed of a rubber compound that is different from the rubber compound of the main layer 7P (hatched section in FIG. 2), with all the other aspects being identical, meaning that it is not necessary to describe them again.

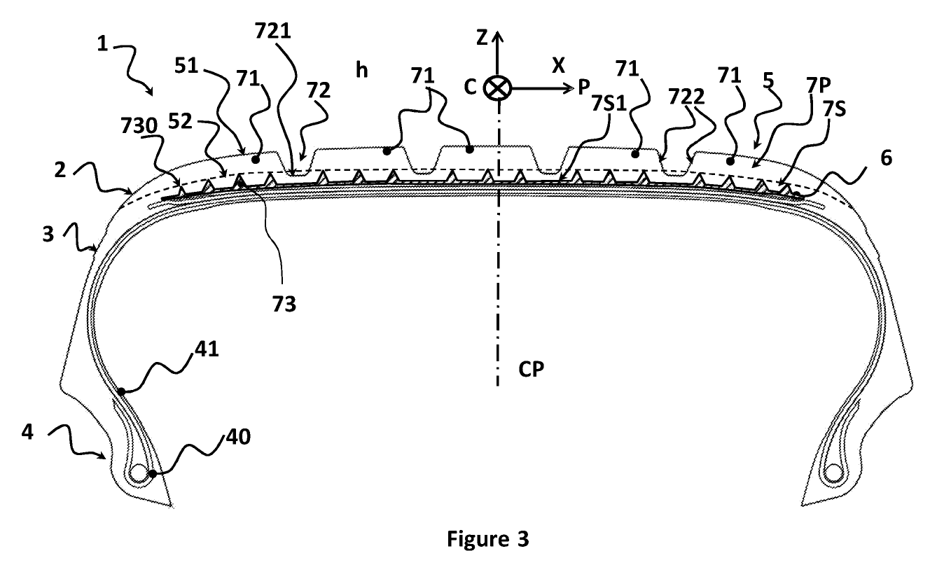

FIG. 3 shows a variant embodiment of the tyre according to the invention, in which it can be seen that a portion of the sublayer is formed of a base layer 7S1 directly covering the crown reinforcement 6, formed of the same material as the circumferential reinforcing elements 72. Said base layer extends radially over a height equal to less than 10% of the radial thickness “h” of said sublayer 7S. The rest of the sublayer is formed of the same rubber compound as the main layer 7P.

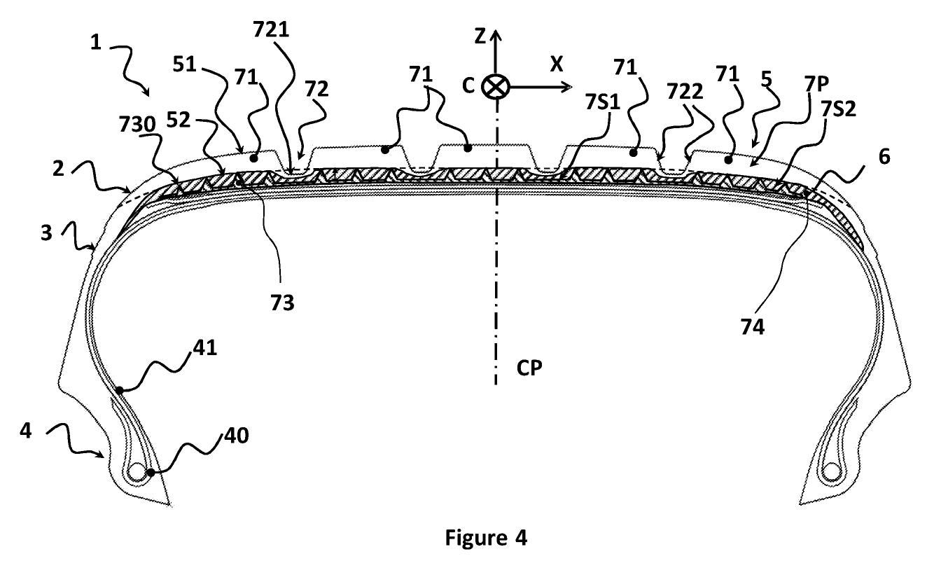

FIG. 4 shows a variant embodiment of the tyre according to the invention, in which the sublayer comprises a base layer 7S1 (formed as described above) and a second layer 7S2, formed, like the sublayer of FIG. 2, of a rubber compound that is different both from the rubber compound forming the circumferential reinforcing elements 73 and from the rubber compound of the main layer 7P, for example a rubber compound stiffer than that of the main layer 7P and less stiff than that forming the circumferential reinforcing elements 73.

In terms of the radial height “h” of the circumferential reinforcing element 73, it may vary from approximately 30% of the thickness “p” of the sublayer to 120% of said thickness “p”. This makes it possible to obtain a significant reinforcing effect. It should further be noted that, in all the embodiments illustrating the invention, the radial end 730 of said circumferential reinforcing elements 73 is located radially at the level of said wear limit. More generally, it is suitable for the radial end 730 of said circumferential reinforcing elements 73 to be situated radially below or substantially at the level of said wear limit.

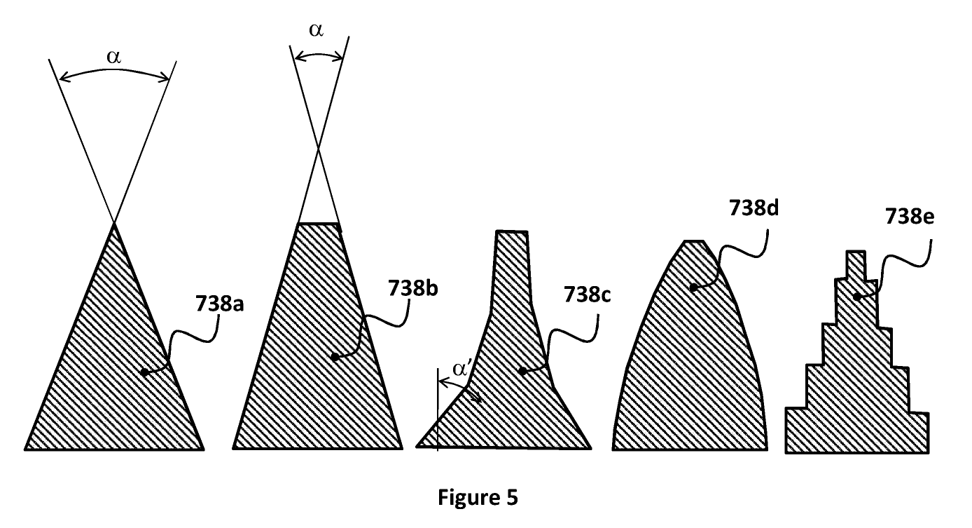

The shape of the circumferential reinforcing elements depicted is triangular, but this shape may vary and the lateral walls may be concave, convex or in the form of a staircase, notably without departing from the scope of this invention. The reader may refer to FIG. 5 in which a circumferential reinforcing element 738a viewed in meridional section has the shape of a triangle as used in all the earlier illustrations, the lateral walls, viewed in meridional section, therefore being straight lines. Preferably, the angle α formed by the two lateral walls of the circumferential reinforcing element(s) is between 35 and 45 degrees. Below 35 degrees, the effectiveness of the bearing point is reduced, and beyond 45 degrees, the volume of the circumferential reinforcing element becomes too great.

The walls of this circumferential reinforcing element may be concave, convex or in the form of a staircase. Thus, in the variant formed by the circumferential reinforcing element 738b, the meridional section thereof is a trapezium. In the variant formed by the circumferential reinforcing element 738c, the lateral walls viewed in meridional section are straight-line segments, the angle α′ that each of these segments forms with the radial direction varying from one segment to the next (decreasing with increasing radial proximity to the outside in the figure). In the variant formed by the circumferential reinforcing element 738d, the lateral walls viewed in meridional section are curved, convex; they could be concave. In the variant formed by the circumferential reinforcing element 738e, the lateral walls viewed in meridional section form staircases. These variations in the shape of the meridional section can be used with all the variants described hereinabove.

The circumferential reinforcing elements need to serve as a bearing point for opposing the shearing of the sublayer. For this purpose, the compound constituting these circumferential reinforcing elements is very stiff.

Table 1 below gives an example of such a formulation.

TABLE 1

| Constituent | C. 1 (in phr) |
|---|---|
| NR (1) | 100 |
| Carbon black (2) | 70 |
| Phenol-formaldehyde resin (3) | 12 |
| ZnO (4) | 3 |
| Stearic acid (5) | 2 |
| 6-PPD (6) | 2.5 |
| HMT (7) | 4 |
| Sulfur | 3 |
| CBS (8) | 2 |

(1) Natural rubber;
(2) Carbon black N326 (name according to standard ASTM D-1765);
(3) Phenol-formaldehyde novolac resin (Peracit 4536K from Perstorp);
(4) Zinc oxide (industrial grade - Umicore);
(5) Stearin (Pristerene 4931 from Uniqema);
(6) N-(1,3-dimethylbutyl)-N-phenylparaphenylenediamine (Santoflex 6-PPD from Flexsys);
(7) Hexamethylenetetramine (from Degussa);
(8) N-cyclohexylbenzothiazolesulfenamide (Santocure CBS from Flexsys).

This formulation makes it possible to obtain compounds with high stiffness. The dynamic shear modulus G* measured under an alternating shear stress of 0.7 MPa at 10 Hz and 60 degrees Celsius is 30.3 MPa.

This very stiff material for the circumferential reinforcements is preferably used with treads of low stiffness, of which table 2 gives an example of a suitable formulation:

TABLE 2

| Composition | B1 (phr) |
|---|---|
| SBR (a) | 100 |
| Silica (b) | 110 |
| Coupling agent (c) | 9 |
| Liquid plasticizer (d) | 20 |
| Resin plasticizer (e) | 50 |
| Black | 5 |
| Zinc oxide | 3 |
| Stearic acid | 2 |
| Antioxidant (f) | 2 |
| Accelerator (g) | 2 |
| DPG | 2 |
| Sulfur | 1 |

The formulations are given by weight.
(a) SBR with 27% styrene, 1,2-butadiene: 5%, cis-1,4-butadiene: 15%, trans-1,4-butadiene: 80%; Tg = −48° C.
(b) Zeosil1165MP silica from Solvay with BET surface area of 160 m²/g
(c) SI69 TESPT silane from Evonik
(d) Flexon 630 TDAE oil from Shell
(e) Escorez 2173 resin from Exxon
(f) Santoflex 6PPD antioxidant from Solutia
(g) Santocure CBS accelerator from Solutia
phr: parts by weight per 100 parts of elastomer.

The dynamic shear modulus G* after vulcanization is 0.9 MPa.

1.-8. (canceled)

9. A tire comprising a crown reinforcement and a tread radially outside the crown reinforcement, the tread comprising:
at least two grooves extending at least partially circumferentially, each groove being delimited radially toward the inside by a groove bottom, the tread having a contact face intended to come into contact with the roadway when the tire is being driven on and a wear limit level situated radially on the outside of the groove bottom;
a plurality of tread pattern blocks, two axially adjacent blocks being axially separated by one of the at least two grooves;
at least two radially superposed layers including a sublayer covering the crown reinforcement and a main layer radially above the crown reinforcement,
wherein the sublayer comprises at least two circumferential reinforcing elements arranged axially between two axially consecutive grooves,
wherein the circumferential reinforcing elements are formed of a rubber compound having greater stiffness than the stiffness of a rubber compound of the rest of the sublayer, and
wherein the circumferential reinforcing elements extend radially from a radially exterior surface of the crown reinforcement in the direction of an interface between the sublayer and the main layer, each circumferential reinforcing element having an axial width which decreases gradually, with increasing radial proximity to an exterior of the tread, until a radial end thereof.

10. The tire according to claim 9, wherein the dynamic shear modulus G* of the rubber compound of the circumferential reinforcing elements is at least two times greater than the dynamic shear modulus G* of the rubber compound of the rest of the sublayer.

11. The tire according to claim 9, wherein the sublayer extends radially substantially as far as the wear limit level.

12. The tire according to claim 9, wherein the radial end of each circumferential reinforcing element is situated radially below or substantially at the wear limit level.

13. The tire according to claim 9 comprising at least three circumferential reinforcing elements distributed axially between two grooves.

14. The tire according to claim 9, wherein the sublayer comprises a base layer directly covering the crown reinforcement, formed of a same material as the circumferential reinforcing elements, the base layer extending radially over a height equal to less than 10% of a radial thickness h of the sublayer.

15. The tire according to claim 9, wherein each circumferential reinforcing element forms a triangle, viewed in meridional section, and an angle of lateral walls of the triangle is between 35° and 45°.

16. The tire according to claim 9, wherein the rubber compound of the circumferential reinforcing elements has a dynamic shear modulus G*, measured at 60° C. at 10 Hz and under an alternating shear stress of 0.7 MPa, of greater than 3 MPa, and a rubber compound constituting the main layer has a dynamic shear modulus G*, measured at 60° C. at 10 Hz and under an alternating shear stress of 0.7 MPa, of less than 1.6 MPa.
